(19) United States
(12) Patent Application Publication
(10) Pub. No.: US 2015/0070395 A1
(43) Pub. Date: Mar. 12, 2015

(54) PORTABLE DEVICE AND METHOD FOR CONTROLLING THE SAME

(71) Applicant: Seungil KIM, Seoul (KR)

(72) Inventor: Seungil KIM, Seoul (KR)

(21) Appl. No.: 14/484,290

(22) Filed: Sep. 12, 2014

(30) Foreign Application Priority Data
Sep. 12, 2013 (KR) 10-2013-0109719

(51) Int. Cl. G09G 5/38

(52) U.S. Cl. CPC G09G 5/38
USPC 345/659

(57) ABSTRACT

The present invention relates to a portable device performing various operations based on orientation information and wobble information of the portable device and a method for controlling the same.

To achieve these objects and other advantages, the present invention provides a method for controlling a portable device, comprising steps of: performing a first operation of the portable device; obtaining orientation information of the portable device, wherein the orientation information of the portable device includes orientation angle information of the portable device and time information on how long the orientation is maintained; obtaining wobble information of the portable device; determining whether the orientation information and the wobble information meet a predefined condition; and if the predefined condition is met, performing a second operation of the portable device, and a portable device using the same.

This application claims priority to and the benefit of Korean Patent Application No. 10-2013-0109719, filed on Sep. 12, 2013, which is hereby incorporated by reference as if fully set forth herein.

### BACKGROUND OF THE INVENTION

1. Field of the Invention

The present invention relates to a portable device and a method for controlling the same, and more particularly, to a portable device performing various operations of the device based on orientation information and wobble information and a method for controlling the same.

2. Discussion of the Related Art

A portable device is a general term for digital devices that a user may carry with for usage, including a smartphone, a tablet PC, a smart watch, and various other forms of digital devices. With the recent appearance of various types of portable devices with improved performance, a portable device gets to be capable of executing various forms of multimedia content, not executing only specific functions as in traditional devices.

Further, recent portable devices are equipped with various sensors. A portable device is capable of sensing various conditions around the device and its user by using sensors mounted in the device. Therefore, a portable device may provide various context aware services to its users by using values sensed by various sensors mounted on the portable device. For example, a portable device may provide various forms of multimedia content by considering the context based on values sensed by its sensors.

### SUMMARY OF THE INVENTION

The present invention aims to provide context aware services to a user of a portable device. More specifically, the present invention aims to execute and control various operations of a portable device based on orientation information and wobble information sensed by the portable device.

To achieve these objects and other advantages and in accordance with the purpose of the invention, as embodied and broadly described herein, a method for controlling a portable device comprises performing a first operation of the portable device; obtaining orientation information of the portable device, wherein the orientation information of the portable device includes orientation angle information of the portable device and time information on how long the orientation is maintained; obtaining wobble information of the portable device; determining whether the orientation information and the wobble information meet a predefined condition for them; and if the predefined condition is met, performing a second operation of the portable device.

Further, the portable device according to embodiments of the present invention comprises a processor controlling the operations of the portable device; and a sensor unit sensing the orientation information and the wobble information of the portable device and delivering them to the processor, wherein the processor performs the first operation of the portable device and obtains the orientation information and the wobble information of the portable device by using the sensor unit, wherein the orientation information of the portable device includes the orientation angle information of the portable device and the time information on how long the orientation is maintained, dermines whether the orientation information and the wobble information meet the predefined condition, and performs the second operation of the portable device, if the predefined condition is met.

According to embodiments of the present invention, the portable device is capable of providing necessary services at a proper time point to its user, by determining user's intention precisely and performing operation switching and content switching based on the user's intention.

Further, according to embodiments of the present invention, predefined operations may be performed only when predefined patterns on orientation and wobble for the portable device are met, through which content security of the portable device is kept.

### BRIEF DESCRIPTION OF THE DRAWINGS

FIG. 1 is a block diagram illustrating a portable device according to an embodiment of the present invention.

FIG. 2 is a flowchart illustrating a method for controlling a portable device according to an embodiment of the present invention.

FIGS. 3 to 7 are drawings illustrating embodiments where a portable device in the present invention provides posture correction content to its user based on orientation information and wobble information.

FIGS. 8 and 9 are drawings illustrating embodiments where a portable device in the present invention executes a camera application based on orientation information and wobble information.

FIGS. 10 and 11 are drawings illustrating embodiments where a portable device in the present invention releases content lock based on orientation information and wobble information.

### DETAILED DESCRIPTION OF THE INVENTION

For terms used in the present description, current general terms used widely were selected by considering functions of the present invention, but terms may vary according to intention of those skilled in the art, usual practices, or introduction of new technologies. Some of the terms mentioned in the description of the present invention may have been selected by the applicant at his or her discretion, and in such cases the detailed meanings thereof will be described in relevant parts of the description herein. Thus, the terms used in the present description should be interpreted based on substantial meanings of the terms and the whole content of the present description rather than their simple names or meanings.

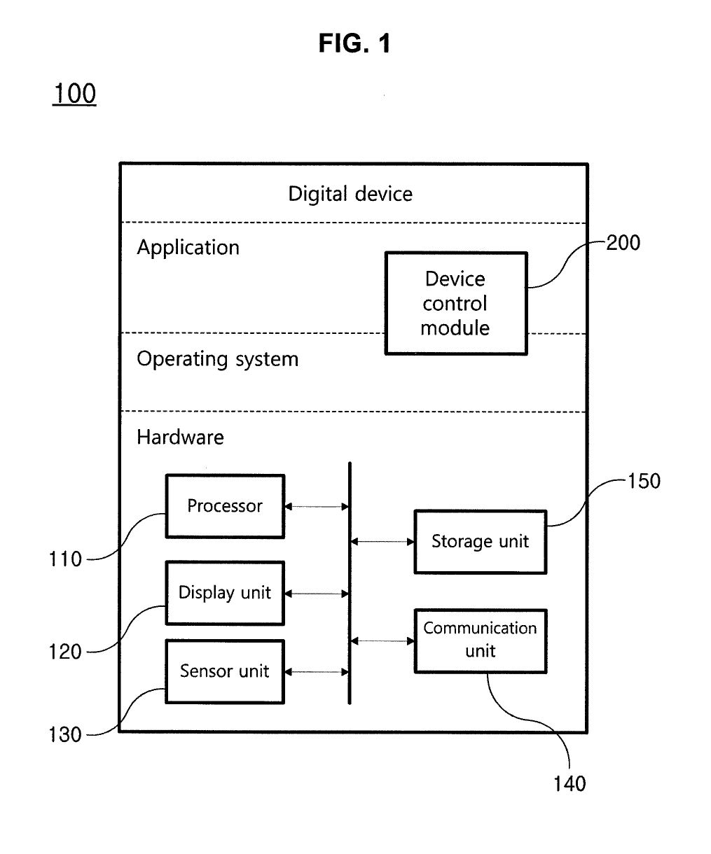

FIG. 1 is a block diagram illustrating a portable device 100 according to one embodiment of the present invention. Referring to FIG. 1, the portable device 100 in the present invention may comprise a hardware layer, an operating system layer, and an application layer.

First, the hardware layer of the portable device 100 may comprise a processor 110, a display unit 120, a sensor unit 130, a communication unit 140, and a storage unit 150.

The display unit 120 outputs images onto a display screen. The display unit 120 is capable of outputting the images based on content executed by the processor 110 or a control command of the processor 110. In the present invention, the display unit 120 may include a touch sensitive display unit.

The sensor unit 130 is capable of detecting conditions around the portable device 100 through at least one of sensors mounted on the portable device 100 and delivering the detected data to the processor 110. Also, the sensor unit 130 is capable of detecting user's inputs and delivering them to the processor 110. In this case, the sensor unit 130 may include at least one sensing means. As one embodiment, at least one sensing means may include a gravity sensor, a geomagnetic sensor, a motion sensor, a gyro sensor, an acceleration sensor, an infrared sensor, an inclination sensor, a brightness sensor, an altitude sensor, an odor sensor, a temperature sensor, a depth sensor, a pressure sensor, a bending sensor, an audio sensor, a video sensor, a Global Positioning System (GPS) sensor, a touch sensor, a fingerprint sensor, etc. The sensor unit 130 is a generic term for various sensing means described above, and is capable of detecting various user inputs and the conditions around the portable device 100 and delivering the sensed data to the processor 110 so as to enable the processor 110 to perform corresponding operations. The above-described sensors may be included as individual elements in the portable device 100 or may be included as at least one integrated element in the portable device 100.

According to the embodiment of the present invention, the portable device 100 is capable of obtaining orientation information of the portable device 100 through the sensor unit 130. The orientation information of the portable device 100 in the present invention may include orientation angle information of the portable device 100 and time information on how long the orientation is maintained. The orientation angle information of the portable device 100 may include at least one of a panning angle, a tilting angle, and a yaw angle of the portable device 100. The portable device 100 is capable of detecting the panning angle, the tilting angle, and the yaw angle based on a reference orientation through the sensor unit 130. According to one embodiment of the present invention, the portable device 100 is capable of obtaining the orientation information through an acceleration sensor. For example, the portable device 100 is capable of measuring a tilting angle of the corresponding device by referencing at least one of arbitrary x-axis, y-axis, and z-axis through the acceleration sensor, and is capable of obtaining the orientation information of the portable device 100 based on the tilting angle. According to another embodiment, the portable device 100 is capable of obtaining the orientation information through the gyro sensor. In this case, the portable device 100 is capable of defining an arbitrary reference orientation and obtaining the orientation information by detecting rotation angle of the portable device based on the corresponding reference orientation. However, the method for obtaining the orientation information of the portable device 100 in the present invention is not limited thereto, and may be modified variously.

According to the embodiment of the present invention, the portable device 100 is capable of obtaining the wobble information of the portable device 100 through the sensor unit 130. In this case, the wobble information may be obtained along with wobble pattern information and wobble duration information of the portable device 100. The portable device 100 is capable of obtaining the wobble information through an acceleration sensor, a gyro sensor, or an impact sensor.

Next, the communication unit 140 is capable of transmiting/receiving data while communicating with external devices or servers through various protocols. In the present invention, the communication unit 140 is capable of accessing a server or a cloud through a network and transmiting/receiving digital data, for example content. In the present invention, the communication unit 140 may be selectively mounted on the portable device 100.

Next, the storage unit 150 of the present invention is capable of storing digital data, including various forms of content such as videos, audios, photos, and applications. The storage unit 150 includes various storage media for digital data, including a flash memory, a Random Access Memory (RAM), or a Solid State Drive (SSD). Further, the storage unit 150 is capable of storing content that the communication unit 140 receives from external devices or servers.

The processor 110 of the present invention is capable of executing the content stored in the storage unit 150, or the content received through data communication. Further, the processor 110 is capable of executing various applications and processing internal data of the portable device 100. When the content executed by the processor 110 contains image data, the display unit 120 is capable of displaying the image of the executed content based on commands of the processor 110. In the embodiment of the present invention, the processor 110 is capable of operating a device control module 200 and performing operations of the portable device 100 based on the control command of the device control module 200. Additionally, the processor 110 is capable of controlling individual units of the above described portable device 100 and controlling data transmission/reception among the units.

Next, the operating system (OS) layer of the portable device 100 may include an operating system controlling individual units of the portable device 100. The operating system enables applications of the portable device 100 to control and use individual units on the hardware layer. The operating system distributes resources of the portable device 100 efficiently, and prepares the environment for execution of individual applications. In the present invention, the term, “operating system”, is used as a comprehensive concept that includes embedded softwares such as middlewares. Meanwhile, the application layer of the portable device 100 may include at least one application. The application includes various forms of programs to enable a specific operation to be performed. The application is capable of using resources of the hardware layer based on the operating system.

According to the embodiment of the present invention, the portable device 100 is equipped with a device control module to control the execution of various operations of the portable device 100 by collaborating with individual units of the hardware layer. According to the embodiment of the present invention, the device control module 200 may be mounted on the operating system, or an application. For example, the device control module 200 may be the embedded module integrated into the operating system of the portable device 100, or a module provided by the application itself.

The portable device 100 illustrated in FIG. 1 is a block diagram according to one embodiment of the present invention, where individual blocks with marks are illustrated as logically distinguished elements of the device. Accordingly, the elements of the above described device may be mounted in a single chip or in multiple chips, depending on device design.

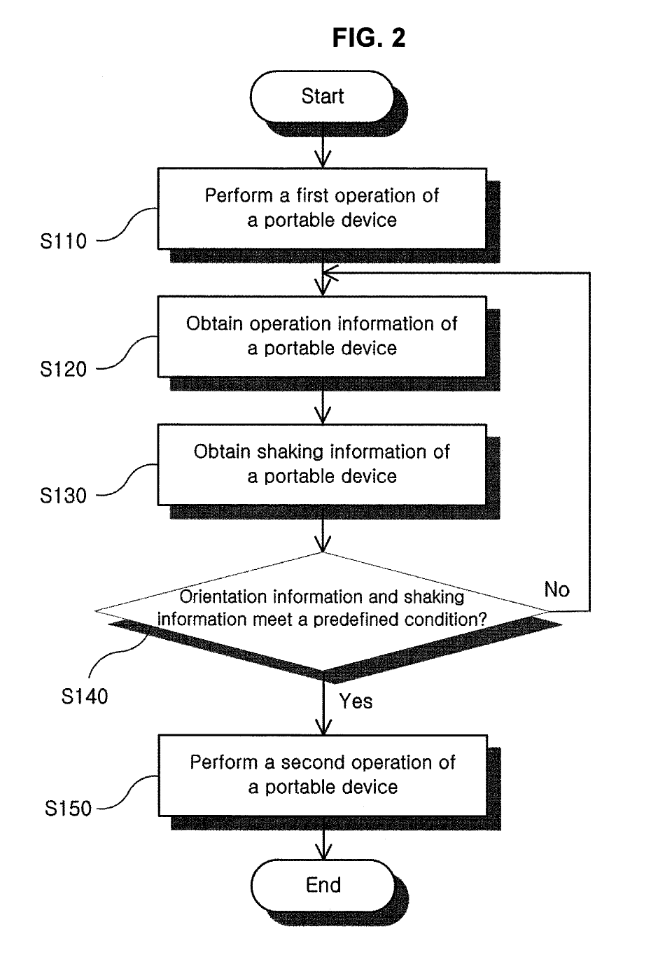

FIG. 2 is a flowchart illustrating a method for controlling the portable device according to an embodiment of the present invention. Each step of FIG. 2 described below may be performed by a portable device of the present invention. For example, the processor 110 in the portable device 100 is capable of controlling each step in FIG. 2, based on the control command of the device control module 200 of the portable device 100 illustrated in FIG. 1.

First, the portable device of the present invention performs a first operation of the portable device (S110). In the embodiment of the present invention, the operation of the portable device is a comprehensive concept including every kind of operation executed or controlled by the portable device. For example, the operation may include replaying a video, replaying music, displaying content, providing a web browser, taking a picture with a camera, executing an application, or executing other various multi-media content, but the present invention is not limited thereto. The operation of the portable device includes every function and operation that may be performed by the portable device.

Next, the portable device of the present invention obtains orientation information of the portable device (S120). The orientation information of the portable device includes orientation angle information of the portable device and time information on how long the orientation is maintained. As described above, the orientation angle of the portable device includes at least one of panning angle, tilting angle, and yaw angle of the portable device. The portable device is capable of detecting the panning angle, the tilting angle, and the yaw angle based on an arbirary reference orientation by using the sensor unit. As one embodiment, the portable device is capable of detecting the orientation angle by using an acceleration snesor, or a gyro sensor, and is capable of detecting the time the operation is maintained by using GPS or a timer.

Next, the portable device of the present invention obtains wobble information of the portable device (S130). In this case, wobble pattern information and wobble duration information of the portable device are able to be obtained with the wobble information. The portable device is capable of obtaining the wobble information through an acceleration sensor, a gyro sensor, or an impact sensor.

Next, the portable device of the present invention determines whether the orientation information and the wobble information meet a predefined condition (S140). Specifically, the portable device is capable of determining whether the wobble pattern of the portable device is continuous or not. For example, the portable device may determine whether the portable device wobbles continuously or intermittently. According to one embodiment, if the portable device wobbles continuously, it may be determined that the user holds the portable device, and if the portable device wobbles intermittently, it may be determined that touch inputs are performed intermittently with the portable device held by a fixing means such as a cradle. According to another embodiment of the present invention, the portable device may determine whether the wobble pattern of the portable device meets a predefined wobble pattern. In this case, at least one predefined wobble pattern may represent how each portable device is held (for example, whether the portable device is held by its user or a fixing means such as cradle). The portable device is capable of determining which predefined wobble pattern meet the wobble pattern of the portable device most closely, and may obtain the holding condition of the portable device based on the determination.

Further, the portable device is capable of determining whether the orientation of the portable device is maintained within a predefined range of angle for a predefined time or more. According to one embodiment, the portable device is capable of determining whether the orientation of the portable device is maintained within a certain range for a predefined time or more based on an orientation on a specific timepoint. According to another embodiment of the present invention, a possible azimuth and/or altitude of the portable device may be divided into multiple predefined intervals, and it may be determined whether the orientation of the portable device is maintained within a specific interval for a predefined duration or more. When the portable device of the present invention meets the described conditions, the orientation of the portable device may be considered to be fixed.

Further, the portable device is capable of determining whether the wobble time of the portable device is greater than or equal to a predefined time. According to a desirable embodiment, the portable device is capable of determining whether the wobble time equals to or is greater than the predefined time, and if no wobble is detected, the measurement of wobble duration may be reset. It is possible to measure whether the portable device wobbles or not based on not only absolute criteria but relative criteria. For example, when the sensed value doesn't exceed a predefined critical value by considering sensitivity of a sensor that detects the wobble, it may be determined that the portable device does not wobble.

Likewise, in S140, the portable device of the present invention is capable of determining at least one of whether the wobble pattern of the portable device is continuous or not (or, whether the wobble pattern of the portable device meets a predefined wobble pattern), whether the orientation of a portable device is maintained in the predefined range of angle for the predefined time or more, and whether the wobble time of the portable device equals to or is greater than the predefined time.

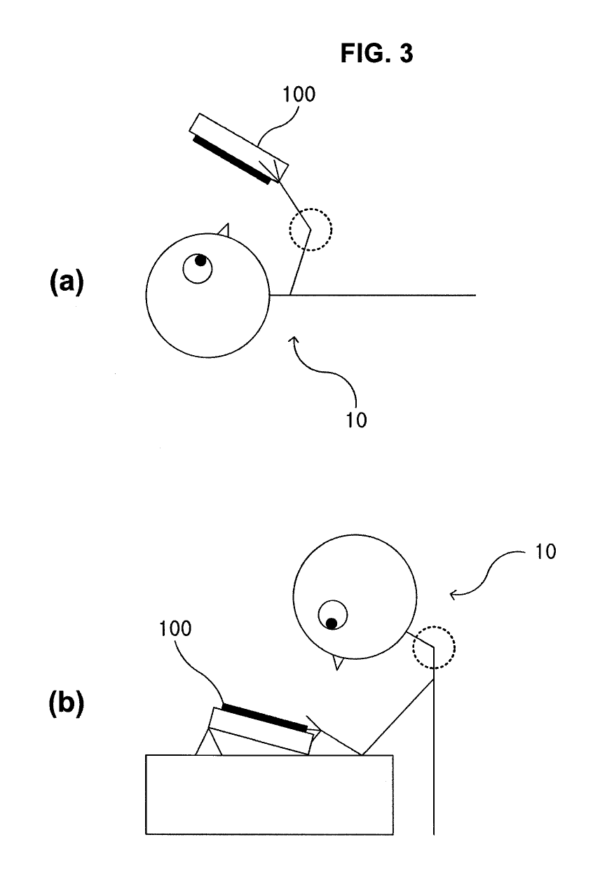

If the orientation information and the wobble information meet the predefined conditions, the portable device of the present invention performs a second operation of the portable device (S150). The second operation is different from the first operation, and may include various embodiments, which will be described by referring FIGS. 3 to 9. According to one embodiment of the present invention, when the wobble pattern of the portable device is continuous, the orientation is maintained within the predefined range of angle for the predefined time or more, and the wobble time is maintained for the predefined time or more, the portable device is capable of performing the second operation. However, the present invention is not limited thereto, and can be changed into various embodiments by combining the conditions described above. Likewise, the portable device of the present invention switches operations based on the orientation information and the wobble information. Meanwhile, when at least one of the orientation information and the wobble information doesn't meet the predefined condition, it is possible that the portable device of the present invention doesn't switch into the second operation. The portable device is capable of performing the first operation continuously by repeating steps S120 to S140.

FIGS. 3 to 9 illustrate detailed embodiments illustrating the portable device 100 according to the present invention performing operations based on the orientation information and the wobble information.

First, as a first embodiment of the present invention, FIGS. 3 to 7 illustrate a method of the portable device 100 providing posture correction content to a user 10 based on orientation information and wobble information.

FIG. 3 illustrates two postures of a user 10 who is using the portable device 100. When a user uses the portable device 100 with a wrong posture, RSI (Repetitive Strain Injury) may be caused. As the user holds the portable device 100 with his/her elbow bent as illustrated in FIG. 3(a), tennis elbow may be caused. Further, the posture illustrated in FIG. 3(b) may strain muscles in upper back and neck as the head go forward. Therefore, the posture may cause ‘Turtle neck syndrom’, which is a forward head posture. To prevent such RSI, a break timer may be used to force the user 10 to break periodically, but it has a limitation as it considers only the time the user uses the portable device 100, not the posture of the user. According to the embodiment of the present invention, the portable device 100 may obtain the orientation information and the wobble information of the portable device, and may infer users' body parts that are exposed to pain based on such information.

First, the wobble information of the portable device may be a clue on how much the user 10 uses his/her arms or wrists. If the portable device 100 is shaken continuously, it may be determined that the user 10 holds the portable device 100 with a hand. If the portable device 100 is not shaken, it may be determined that the portable device 100 is fixed with a fixing means. For example, the portable device 100 may be placed on a cradle, or be placed on a table. In this case, as elbows or wrists of the user 10 do nothing on the portable device, it may be determined that the portable device is not exposed to the risk of RSI. Further, if the portable device 100 is shaken intermittently, it may be determined that the user 10 performs typing or touch input operations with the portable device 100 fixed.

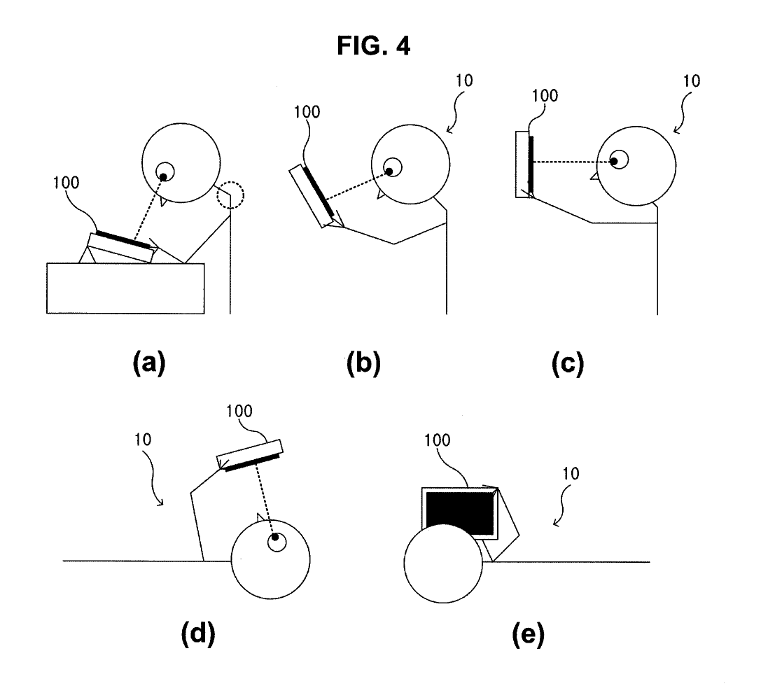

Next, the orientation information of the portable device 100 may be used to infer user 10's posture. According to an embodiment of the present invention, the portable device 100 may detect, based on the orientation information, a posture that strains a specific body part, including a neck, an elbow, and a wrist of a user 10. For example, if the user 10's orientation toward the portable device is perpendicular to the display pane of the portable device 100, it may be inferred how much user's neck is bent. Further, the orientation information of the portable device 100 may be used to infer the posture of arms. FIG. 4 illustrates several embodiments of user's posture toward the portable device 100.

First, FIG. 4(a) illustrates a posture where a user 10 places the portable device on a table while using the device. In this case, the user stoops over the device too much, which is not good for the neck of the user. Meanwhile, maybe the posture doesn't strain elbows too much as the elbow is placed on the table. However, if two hands are placed on the table for performing a typing operation on the portable device 100, the user may feel pains on wrists. FIG. 4(b) illustrates a posture where a user 10 stoops the head a little while holding the portable device 100, which may cause neck pains easily with extended operation. Further, if the posture is maintained for extended time, pains may be caused on wrists and elbows. FIG. 4(c) illustrates a user 10 holding the portable device 100, where the portable device 100 is leveled to the eyes of the user 10. This posture may cause little pains in neck, but pains may be caused on wrists and elbows if the posture is maintained for extened time. FIG. 4(d) illustrates a user watching the portable device 100 while lying on his/her back. Therefore, his/her neck or upper back may feel comfortable. However, in this posture, the user supports the portable device with raised arms while lying down on his/her back, which may cause severe pains on wrists or elbows. Last, FIG. 4(e) illustrates a user holding the portable device 100 while lying on his/her side. In this case, the user feels different symptoms of pain on the left side and the right side, respectively. For example, the right arm of the user 10 should be kept raised in the air, which may cause severe strain on wrists or elbows, and the left arm of the user may be pressed under the body to feel numbed or with nerves squeezed.

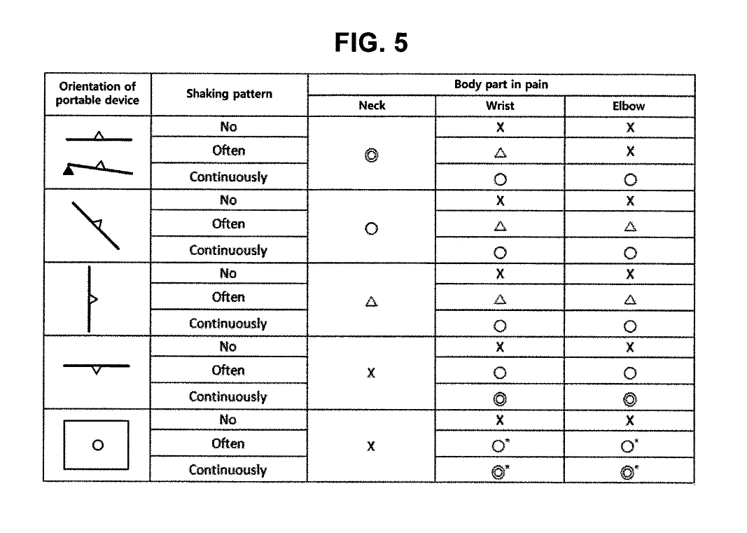

In short, according to an embodiment of the present invention, body parts of the user in pain may be determined based on the orientation information and the wobble information of the portable device 100. FIG. 5 illustrates pain levels of individual body parts when using the portable device for extended time, based on the orientation information and the wobble information of the portable device.

In FIG. 5, the orientation of the portable device in downward sequence represents the orientation of the portable device 100 illustrated in FIGS. 4(a) to 4(e), wherein the line represents the portable device, and the triangle represents the orientation of the display unit of the portable device. Further, the wobble pattern includes No wobble pattern, Often wobble pattern, and Continuously wobble pattern, and pain levels are classified into four levels, including Very strong (⊚), Strong (∘), Normal (Δ), and None (X). The attached * mark indicates that levels and types of pains in the left side and the right side of the user may be varied. However, body part in pains and pain levels classified in FIG. 5 are only examples, and the present invention is not limited thereto.

According to the embodiment of the present invention, when the orientation information and the wobble information of the portable device are obtained, the portable device is capable of inferring body part in pains and pain strength of the user by referring a predefined table like this. As described above, the table represents body part in pains and pain levels of a user based on the orientation information and the wobble information of the portable device comprehensively. According to one embodiment of the present invention, the pain strength (Pk[n]) a user feels in the orientation of the portable device may be calculated as follows:

Pₖ[n]=Pₖ[n−1]+Lₖ[n]t[n] [Formula 1]

Where, Pk[n−1] indicates pain strength in previous orientation, Lk[n] indicates pain level in current orientation, t[n] is duration of the current orientation, and k is an index indicating the body part in pain.

In the embodiment of the present invention, the pain level (Lk[n]) represents a degree of the pain at the moment, and the pain strength (Pk[n]) represents a degree of the pain accumulated by the time. According to Formula 1, the pain strength (Pk[n]) of a user may be calculated based on a value obtained by multiplying weight (Lk[n]) according to the orientation of the portable device, and the duration (t[n]) of the orientation. Further, this pain strength (Pk[n]) of the user may be a value accumulated from a speicific timepoint. Meanwhile, the pain level (Lk[n]) in current orientation may be obtained by referring a predefined table, as described in FIG. 5. The body part in pain represented by the index k may include a neck, a wrist, or an elbow as described above, as well as various other body parts.

The portable device is capable of providing posture correction content based on such calculated pain strength of the user. For example, the portable device may stop a current operation and provide posture correction content, when the pain strength of a specific part exceeds a critical value.

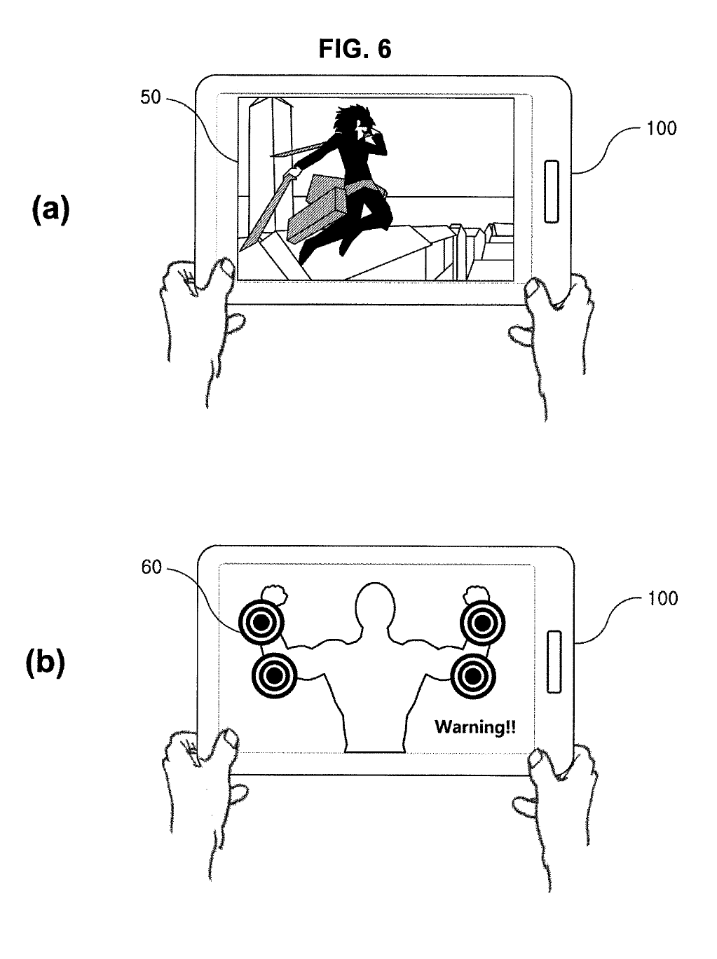

FIG. 6 illustrates one embodiment where the portable device 10 in the present invention provides posture correction content 60. As illustrated in FIG. 6(a), the portable device 100 is capable of replaying movie content 50 as a first operation. In the embodiment of FIG. 6(a), a user enjoys a movie content 50 with the portable device 100 held by a hand. The portable device 100 collects the orientation information and the wobble information of the portable device 100, and is capable of detecting pains in wrists and elbows of the user based on the collected information. When the detected pain strength exceeds a critical value, the portable device 100 is capable of providing posture correction content 60 as illustrated in FIG. 6(b). The posture correction content 60 may indicate information including body part in pain of the user (wrist, elbow) and the pain strength of the body part in pain. In this case, the portable device 100 is capable of providing the information through a display object and/or a voice message. Further, the portable device 100 is capable of stop replaying the movie content 50 in FIG. 6(a) and providing the posture correction content 60, or is capable of providng the posture correction content 60 along with the movie content 50. Likewise, the portable device 100 in the present invention may provide the posture correction content 60 as a second operation.

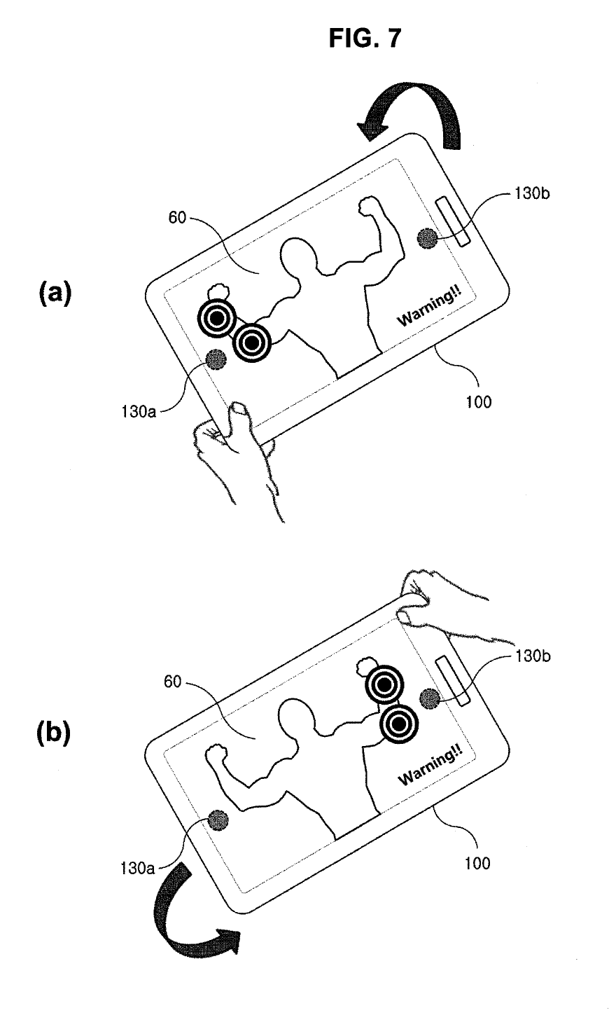

FIG. 7 illustrates another embodiment of the portable device 10 in the present invention providing posture correction content. In the embodiment of FIG. 7, the repeated description in the sections identical to the embodiment of FIG. 6 will be skipped. According to an embodiment of FIG. 7, the portable device 100 may obtain the wobble information of the portable device through multiple sensors 130a and 130b. In this case, the wobble information may include information about at least one of wobble frequency, wobble amplitude, and wobble strength. According to one embodiment of the present invention, the multiple sensors 130a and 130b may be mounted on both ends of the portable device 100, as illustrated in FIG. 7. The sensors 130a and 130b are capable of individually sensing wobble of the portable device 100 and delivering the sensed wobble information to a processor.

As illustrated in FIGS. 7(a) and 7(b), respectively, even though the orientation of the portable device is identical, user's hand holding the portable device 100 may be different. For example, the orientation of the portable device when a user holds the portable device 100 with his/her left hand in FIG. 7(a) and the oreitnation of the portable device when a user holds the portable device 100 with his/her right hand in FIG. 7(b) may be identical. Therefore, it may be difficult to determine user's posture precisely based on only the orientation information of the portable device 100. The portable device 100 of the present invention senses the wobble of the portable device 100 through multiple sensors 130a and 130b to determine the user's posture precisely.

If a user holds the portable device 100 with his/her left hand, as illustrated in FIG. 7(a), the left side of the portable device 100 may wobble more severely than the right side of the portable device 100. Therefore, wobble information sensed through a sensor 130b located in the right side of the portable device 100 may be greater than wobble information sensed through a sensor 130a located in the left side of the portable device 100. Conversely, if a user holds the portable device 100 with his/her right hand, as illustrated in FIG. 7(b), the left side of the portable device 100 may wobble more severely than the right side of the portable device 100. Therefore, wobble information sensed through the sensor 130a located in the left side of the portable device 100 may be greater than wobble information sensed through the sensor 130b located in the right side of the portable device 100. Therefore, the portable device 100 compares wobble information sensed through multiple sensors 130a and 130b, and determines more precisely user's posture by using the compared result and the orientation information of the portable device 100.

In other words, the portable device 100 in FIG. 7(a) is able to recognize that wobble information sensed through the sensor 130b is greater than wobble information sensed through the sensor 130a. The portable device 100 determines that the user holds the portable device 100 with his/her left hand based on the obtained orientation information and the multiple wobble information. Therefore, the portable device 100 is capable of providing the posture correction content 70 that recommends to relax the left wrist and the left elbow, as illustrated in FIG. 7(a). Likewise, the portable device 100 in FIG. 7(b) is able to recognize that wobble information sensed through the sensor 130a is greater than wobble information sensed through the sensor 130b. The portable device 100 determines that the user holds the portable device 100 with his/her right hand based on the obtained orientation information and the multiple wobble information. Therefore, the portable device 100 is capable of providing the posture correction content 60 that recommends to relax the left wrist and the left elbow, as illustrated in FIG. 7(b).

Meanwhile, FIG. 7 illustrates two sensors 130a and 130b sensing wobble of the portable device 100, but depending on an embodiment, it is possible that four sensors are mounted on every corner of the portable device to sense wobble of the portable device 100. However, the number and position of the sensors in the present invention are not limited thereto. Likewise, the portable device 100 may obtain wobble information from multiple sensors mounted on multiple positions of the portable device 100, and may perform the operation based on the obtained multiple wobble information and the orientation information of the portable device 100.

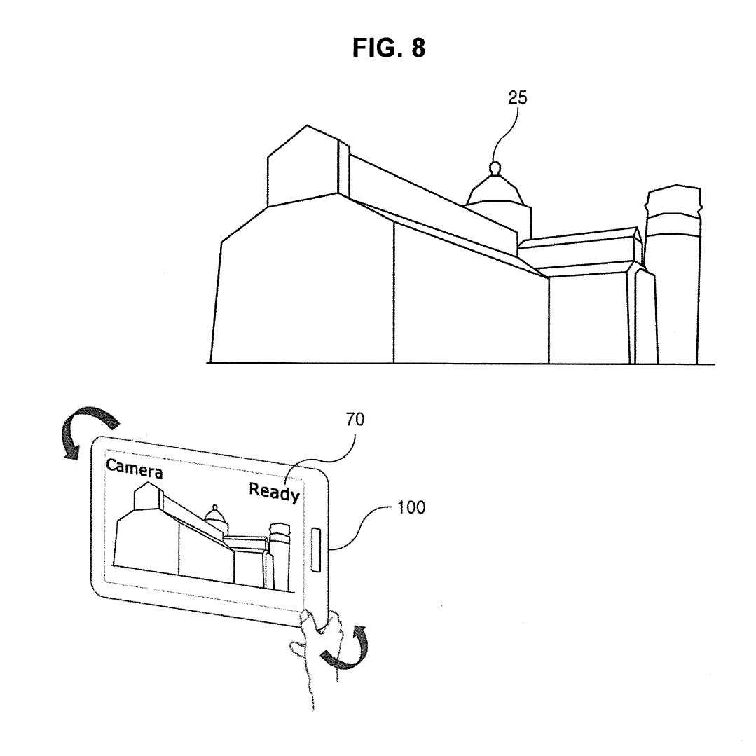

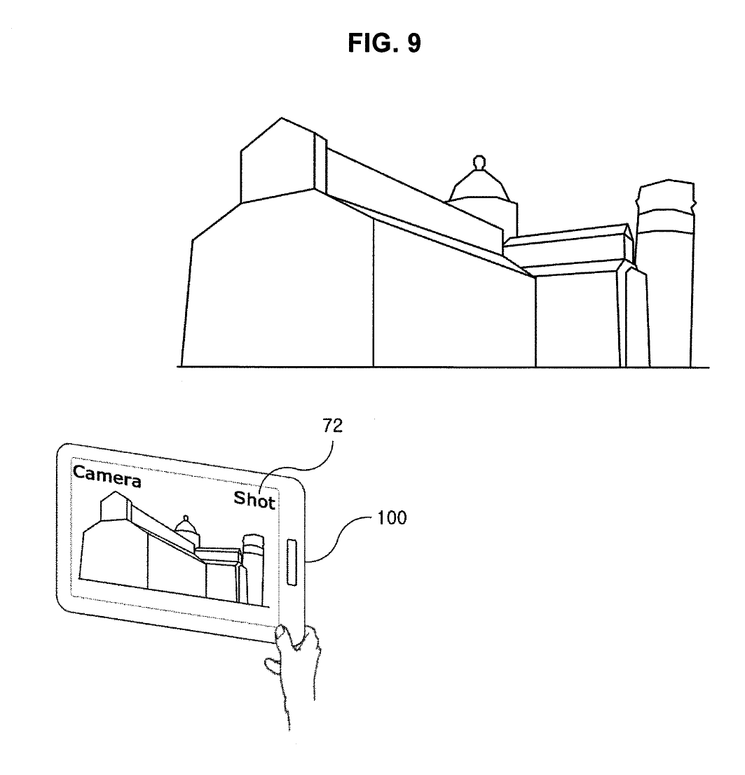

FIGS. 8 and 9, as the second embodiment of the present invention, illustrate a method for executing, by the portable device 100, a camera application based on orientation information and wobble information. Generally, to capture a picture, a user executes the camera application of the portable device, and orients a camera unit (not shown in the drawing) of the portable device 100 to a subject for photography. In this case, the user should press a capture button while holding the portable device 100 toward the subject 25 for photography. However, when the capture button mounted on the portable device 100 is pressed, the portable device 100 may wobble temporarily, which prevents from taking a clear picture. Further, the capture button may be pressed while the portable device 100 is wobbling, which prevents from taking a clear picture, too. According to an embodiment of the present invention, the portable device 100 is capable of taking a picture by using orientation information and wobble information.

First, referring FIG. 8, the portable device 100 of the present invention obtains orientation information and wobble information of the portable device 100 with a state that the camera application is running. The portable device 100 may go into a capture standby mode 70 when the orientation of the portable device is maintained within a certain scope for a predefined time or more. Or, the portable device 100 may go into a capture standby mode 70 when the wobble pattern of the portable device 100 is continuous and the orientation is maintained within a certain scope for a predefined time or more. If the orientation of the portable device 100 is fixed, it may be determined that the user selected a subject 25 to be captured, and is about to take the picture of the subject. The portable device 100 in the capture standby mode 70 is capable of focusing automatically on the subject 25, and is capable of performing other preliminary operations to take a picture of the subject 25.

Next, referring to FIG. 9, the portable device 100 is capable of perform a capture operation 72 when the wobble of the portable device 100 in the capture standby mode 70 of FIG. 8 is below a predefined value. More specifically, the portable device 100 is capable of performing the capture operation 72 when the orientation of the portable device 100 is maintained within a predefined range of angle for a predefined time or more and the wobble is below a predefined value. For example, the portable device 100 may capture an optimum time point when the portable device does not wobble and may take a picture of a subject 25 automatically at the time point. In this case, the predefined range of angle to perform a capture operation 72 may be identical to the predefiend range of angle for the capture standby mode 70 in FIG. 8, but the present invention is not limited thereto.

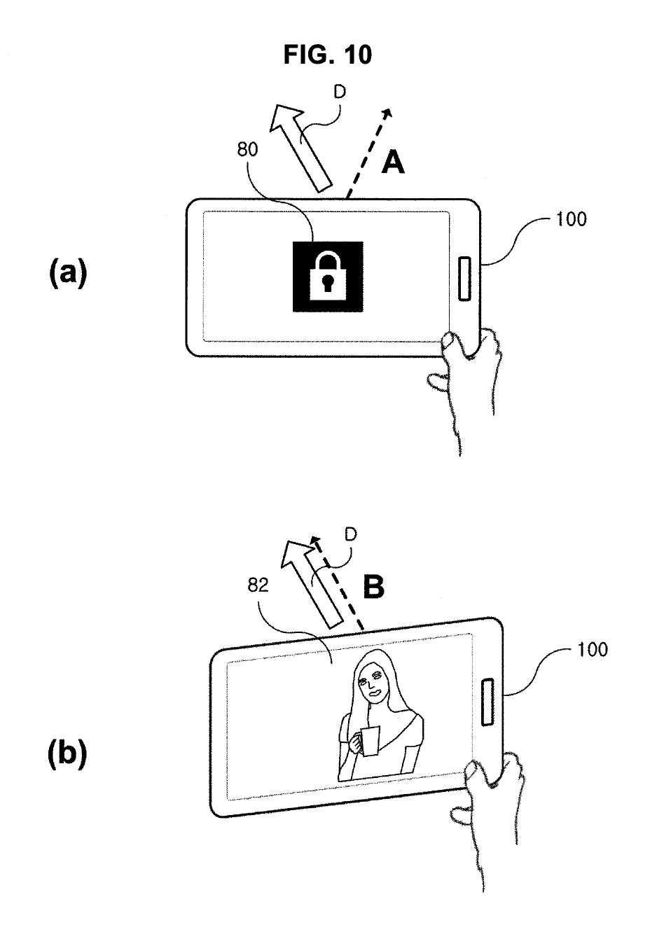

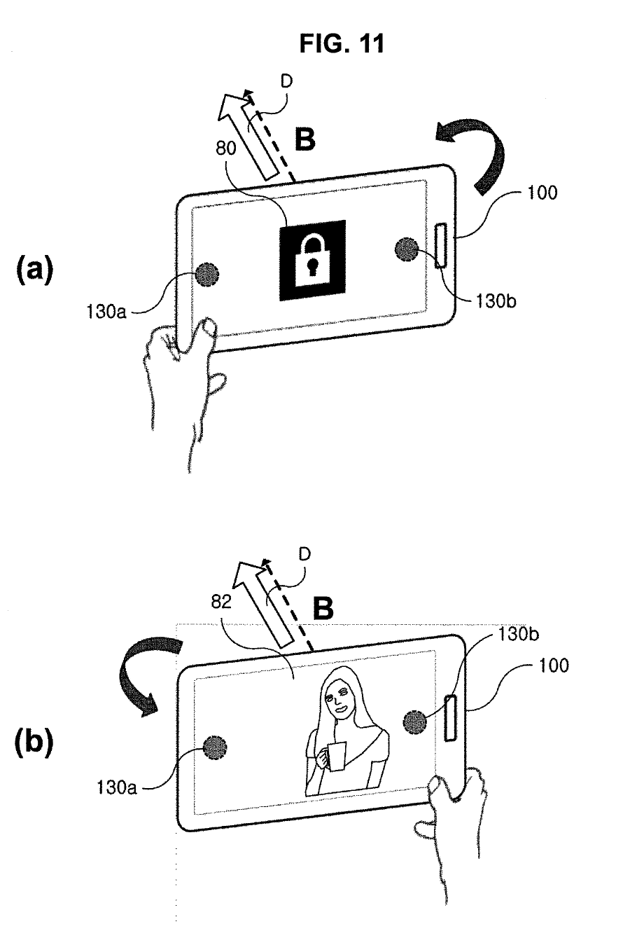

FIGS. 10 and 11, as a third embodiment of the present invention, illustrate a method for releasing, by the portable device 100, content lock based on orientation information and wobble information.

First, FIG. 10 illustrates one embodiment of the portable device 100 in the present invention releasing the content lock. Referring to FIG. 10(a), the portable device 100 is capable of providing a locked content 80. The locked content 80 is content that access to all or part of the content is only allowed to a specific user, and the lock may be released only when the corresponding user is confirmed by approval. For example, the locked content 80 may include various forms of content, such as a locked image, a locked document, a locked picture, a locked home screen, and a combination of them.

According to an embodiment of the present invention, the portable device 100 may use orientation information and wobble information of the portable device 100 to release the lock of the content 80. The portable device 100 is capable of obtaining the information on a predefined pattern of orientation and wobble as a key to release the lock of the content 80, and the lock may be released when the orientation and wobble patterns of the portable device 100 meet the obtained information. According to one embodiment of the present invention, the portable device 100 may release the lock when the orientation of the portable device 100 is maintained within a predefined range of angle for a predefined time or more, and when the wobble pattern is continuous.

In the embodiment of FIG. 10, the predefined orientation to release the lock of the content 80 is ‘D’. Therefore, as illustrated in FIG. 10(a), if the orientation ‘A’ of the portable device 100 is not identical to the predefined orientation ‘D’ of the portable device 100, the portable device 100 may not release the lock of the content 80. However, as illustrated in FIG. 10(b), if the orientation ‘B’ of the portable device 100 is identical to the predefined orientation ‘D’ of the portable device 100 (or, is within a certain range of angle from the predefined orientation ‘D’), the portable device 100 may provide the released content 82. In this case, the portable device 100 may provide the released content 82 when the orientation of the portable device 100 is maintained toward the direction ‘B’ for a specific time or more and the wobble pattern is continuous. The portable device 100 may determine that the user holds the portable device 100 in a predefined orientation, and may release the lock of the content 80.

Next, FIG. 11 illustrates another embodiment of the portable device 100 in the present invention releasing the content lock. In the embodiment of FIG. 11, the repeated description in the sections identical to the embodiment of FIG. 10 will be skipped. According to an embodiment of FIG. 11, the portable device 100 may obtain the wobble information of the portable device through multiple sensors 130a and 130b. As described above, the wobble information may include information about at least one of wobble frequency, wobble amplitude, and wobble strength. According to one embodiment of the present invention, the multiple sensors 130a and 130b may be mounted on both ends of the portable device 100, as illustrated in FIG. 11. According to another embodiment of the present invention, it is possible that four sensors are mounted on four corners of the portable device 100 to sense the wobble of the portable device 100, and the number and the position of the sensors in the present invention are not limited thereto, as described above. The sensors 130a and 130b are capable of sensing wobble of the portable device 100 respectively, and delivering the sensed wobble information to a processor.

As described above in FIG. 7, even with an identical orientation of the portable device 100, the user may hold the portable device 100 with different hands. For example, it is possible that the orientation when a user holds the portable device 100 with his/her left hand as illustrated in FIG. 11(a) and the orientation when a user holds the portable device 100 with his/her right hand as in illustrated in FIG. 11(b) are identical as ‘B’. According to an embodiment of the present invention, the portable device 100 may release the content lock by additionally using the wobble information obtained through multiple sensors 130a and 130b.

If it is defined that the lock of the content 80 is released only when the user holds the portable device 100 with his/her right hand, the portable device 100 may release the content lock only when wobble information sensed through the sensor 130a is greater than wobble information sensed through the sensor 130b, as illustrated in FIG. 11. That is, as illustrated in FIG. 11(a), even though the orientation ‘B’ of the portable device is identical to the predefined orientation ‘D’, if wobble information sensed through the sensor 130b is greater than wobble information sensed through the sensor 130a, the lock of the content 80 may not be released. However, as illustrated in FIG. 11(b), when the orientation ‘B’ of the portable device 100 is identical to the predefined orientation ‘D’ and the wobble information sensed through the sensor 130a is greater than the wobble information sensed through the sensor 130b, the released content 82 may be provided.

In the above description, the present invention is described based on specific embodiments, but those skilled in the art may modify or change them without departing from the spirit and scope of the present invention. Therefore, the results that may be inferred easily from the detailed description and embodiments can be interpreted as falling within the scope of the claims of the present invention.

What is claimed is:

1. A method for controlling a portable device, comprising:
performing a first operation of the portable device;
obtaining orientation information of the portable device, wherein the orientation information of the portable device includes orientation angle information of the portable device and time information on how long the orientation is maintained;
obtaining wobble information of the portable device;
determining whether the orientation information and the wobble information meet a predefined condition; and
performing a second operation of the portable device, if the predefined condition is met.

2. The method of claim 1,
wherein the wobble information includes wobble pattern information and wobble duration information of the portable device.

3. The method of claim 2,
wherein the determining step includes determining at least one among whether the wobble pattern of the portable device is continuous or not, whether the orientation is maintained within a predefined range of angle for a predefined time or more, and whether the wobble time is maintained for a predefined time or more.

4. The method of claim 1,
wherein the obtained wobble information of the portable device include wobble information obtained through multiple sensors, respectively,
wherein the second operation is performed based on the wobble information through the multiple sensors and the orientation information.

5. The method of claim 1,
wherein the step of performing the second operation comprises, providing posture correction content for a user using the portable device.

6. The method of claim 5,
wherein the posture correction content is provided based on a value calculated by multiplying weights according to the orientation, and a duration of the orientation.

7. The method of claim 5,
wherein the posture correction content is provided based on combined information of the obtained orientation information and the wobble information.

8. The method of claim 1,
wherein the step of performing the second operation comprises, releasing content lock of the portable device, and providing the released content.

9. The method of claim 1,
wherein the step of performing the first operation is entering into a camera capture standby mode of the portable device, and
wherein the step of performing the second operation is performing a camera capture operation.

10. The method of claim 9,
wherein the second operation is performed when the orientation of the portable device is maintained within a predefined range of angle for a predefined time or more, and the wobble is below a predefined value.

11. A portable device, comprising:
a processor configured to control operation of the portable device; and
a sensor unit configured to sense orientation information and wobble information of the portable device and delivering them to the processor,
wherein the processor is further configured to:
perform a first operation of the portable device,
obtain the orientation information and the wobble information of the portable device through the sensor unit, wherein the orientation information of the portable device includes orientation angle information of the portable device and time information on how long the orientation is maintained,
determine whether the orientation information and the wobble information meet a predefined condition, and
perform a second operation of the portable device, if the predefined condition is met.

12. The portable device of claim 11,
wherein the wobble information includes wobble pattern information and wobble duration information of the portable device.

13. The portable device of claim 12,
wherein the processor determines at least one among whether the wobble pattern of the portable device is continuous or not, whether the orientation is maintained within a predefined range of angle for a predefined time or more, and whether the wobble time is maintained for a predefined time or more.

14. The portable device of claim 11,
wherein the obtained wobble information of the portable device includes wobble information obtained through multiple sensors, respectively,
wherein the processor performs the second operation based on the wobble information obtained through the multiple sensors and the orientation information.

15. The portable device of claim 11,
wherein the second operation provides posture correction content for a user using the portable device.

16. The portable device of claim 15,
wherein the posture correction content is provided based on a value calculated by multiplying weights according to the orientation, and a duration of the orientation.

17. The portable device of claim 15,
wherein the posture correction content is provided based on combined information of the obtained orientation information and the wobble information.

18. The portable device of claim 11,
wherein the second operation releases content lock of the portable device, and provides the released content.

19. The portable device of claim 11,
wherein the first operation enters into a camera capture standby mode of the portable device, and
whereint the second operation performs a camera capture operation.

20. The portable device of claim 19,
wherein the second operation is performed when the orientation of the portable device is maintained within a predefined range of angle for a predefined time or more, and the wobble is below a predefined value.
